(19) United States
(12) Patent Application Publication
(10) Pub. No.: US 2023/0271515 A1
(43) Pub. Date: Aug. 31, 2023

(54) ELECTRICALLY POWERED VEHICLE

(71) Applicant: TOYOTA JIDOSHA KABUSHIKI KAISHA, Aichi-ken (JP)

(72) Inventor: Tomofumi HAGINO, Toyota-shi (JP)

(21) Appl. No.: 18/174,651

(22) Filed: Feb. 27, 2023

(30) Foreign Application Priority Data
Feb. 28, 2022 (JP) 2022-029811

(51) Int. Cl. B60L 53/12; B60K 1/04; H02J 50/00

(52) U.S. Cl. CPC B60L 53/12; B60K 1/04; H02J 50/005; B60K 2001/0438

(57) ABSTRACT

An electrically powered vehicle is disclosed. The electrically powered vehicle includes a contactless charging module that is attached below a floor panel and contactlessly receives power supply from a power supply module disposed on the ground, and a front guard member and a rear guard member that are disposed adjacent to the contactless charging module in a vehicle longitudinal direction below the floor panel. The front guard member and the rear guard member are disposed to cover a front surface or a rear surface of a casing of the contactless charging module.

### CROSS REFERENCE TO RELATED APPLICATION

This application claims priority to Japanese Patent Application No. 2022-029811 filed on Feb. 28, 2022, which is incorporated herein by reference in its entirety including the specification, claims, drawings, and abstract.

### TECHNICAL FIELD

The present disclosure relates to a structure of an electrically powered vehicle that incorporates a contactless charging module for contactlessly receiving power supply from a power supply module disposed on the ground.

### BACKGROUND

Electrically powered vehicles that incorporate a contactless charging module for contactlessly receiving power supply from a power supply module disposed on the ground are in use. For example, JP 2020-156165 A discloses an electrically powered vehicle that includes a contactless charging module disposed below a front suspension member of the electrically powered vehicle for receiving power supply from a power supply module disposed in a parking lot.

Disposing a contactless charging module below a suspension member toward the front of a vehicle as in the electrically powered vehicle disclosed in JP 2020-156165 A may increase in resistance due to turbulent air flow below the vehicle. To address this issue, there is proposed a structure that includes an under cover attached to the front of the contactless charging module in order to rectify air to suppress the increase in air resistance in the electrically powered vehicle disclosed in JP 2020-156165 A.

### SUMMARY

As the contactless charging module is disposed under the floor of the electrically powered vehicle, the contactless charging module may be damaged upon input of a load from a road surface during traveling of the electrically powered vehicle.

To address this issue, the present disclosure is directed toward the reduction of a load input from a road surface to the contactless charging module attached below a floor panel.

According to an aspect of the present disclosure, there is provided an electrically powered vehicle comprising a contactless charging module attached below a floor panel, the contactless charging module configured to contactlessly receive power supply from a power supply module disposed on the ground, and a guard member disposed adjacent to the contactless charging module in a vehicle longitudinal direction below the floor panel, wherein the guard member is disposed to cover a front surface or a rear surface of the contactless charging module.

Disposing a guard member that covers the front surface or the rear surface of the contactless charging module as described above suppresses input of a load from the road surface directly to the contactless charging module while the electrically powered vehicle is traveling toward the front or the rear, enabling a reduction in the load from the road surface that is input to the contactless charging module.

According to another aspect of the present disclosure, in the electrically powered vehicle, the guard member may include a base that faces the front surface or the rear surface of the contactless charging module and a tip that extends from the base toward the front or the rear of the vehicle, the base may have a lower end surface that protrudes downward with respect to the vehicle relative to the bottom surface of the contactless charging module, and the tip may have an undersurface that forms a sloped surface extending from the lower end surface of the base upward with respect to the vehicle.

As such, in response to input of a load acting in the horizontal direction from the road surface to the front or the rear of the guard member, the sloped surface converts some of the load acting in the vehicle longitudinal direction into a load acting in the vehicle vertical direction, reducing shear force applied to a bolt which fixes the guard member, to thereby suppress damage to the bolt. This in turn suppresses possibility of the guard member dropping off from the electrically powered vehicle, enabling reduction of input of the load from the road surface to the contactless charging module. The sloped surface rectifies air flowing below the floor panel of the electrically powered vehicle, enabling reduction in air resistance, improved electricity consumption and reduced noise.

According to another aspect of the present disclosure, in the electrically powered vehicle, the contactless charging module and the guard member may be attached below a battery pack that is attached below the floor panel.

In this manner, the contactless charging module can be disposed in an area where the temperature does not exceed the tolerable temperature for the contactless charging module.

The present disclosure can reduce the load from the road surface input to the contactless charging module attached below the floor panel.

### BRIEF DESCRIPTION OF DRAWINGS

Embodiments of the present disclosure will be described based on the following figures, wherein:

FIG. 1 is a bottom view of an electrically powered vehicle according to an embodiment as viewed from below;

FIG. 2 is a bottom view of a battery pack, a contactless charging module, and guard members mounted in an electrically powered vehicle according to an embodiment as viewed from below the electrically powered vehicle;

FIG. 3 is a cross section of a battery pack, a contactless charging module, and guard members of an electrically powered vehicle according to an embodiment, the cross section being along A-A in FIG. 2;

FIG. 4 is a cross section of a battery pack, a contactless charging module, and a guard member of an electrically powered vehicle according to an embodiment, the cross section being along B-B in FIG. 2;

FIG. 5 is a detailed cross section of a portion E in FIG. 3;

FIG. 6 is a cross section of a battery pack, a contactless charging module, and guard members of an electrically powered vehicle according to an embodiment, the cross section being along C-C in FIG. 2;

FIG. 7 is a cross section of a battery pack, a contactless charging module, and a guard member of an electrically powered vehicle according to an embodiment, the cross section being along D-D in FIG. 2; and

FIG. 8 is a detailed cross section of a portion F in FIG. 6.

### DESCRIPTION OF EMBODIMENTS

An electrically powered vehicle 10 according to an embodiment will be described below with reference to the accompanying drawings. Arrow FR, arrow UP, and arrow RH in the drawings respectively indicate directions toward the front (toward which the electrically powered vehicle 10 normally travels), upward, and toward the right with respect to the electrically powered vehicle 10. Directions opposite the arrows FR, UP, and RH respectively represent directions toward the rear, downward, and toward the left with respect to the vehicle. In the following description, unless otherwise specified, the terms front/rear, right/left, and up/down respectively represent directions toward the front/rear in the vehicle longitudinal direction, right/left in the vehicle right/left direction (vehicle width direction), and up/down in the vehicle vertical direction.

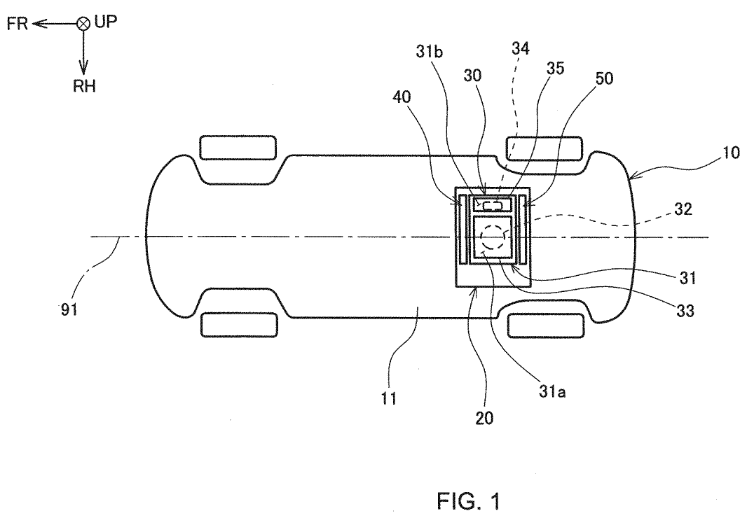

As illustrated in FIG. 1, the electrically powered vehicle 10 according to an embodiment includes a battery pack 20 attached below a floor panel 11, a contactless charging module 30 attached below the battery pack 20, a front guard member 40 disposed in the front direction with respect to the contactless charging module 30, and a rear guard member 50 disposed in the rear direction with respect to the contactless charging module 30.

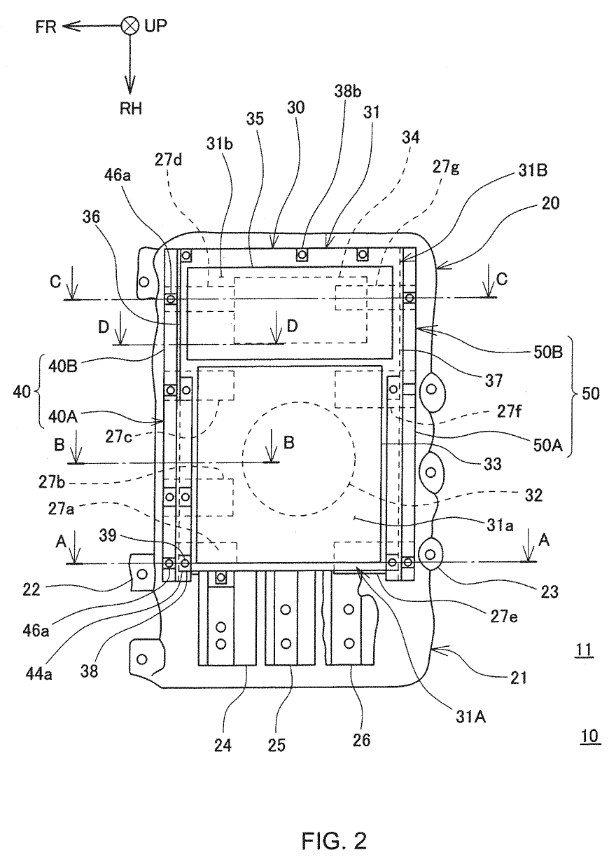

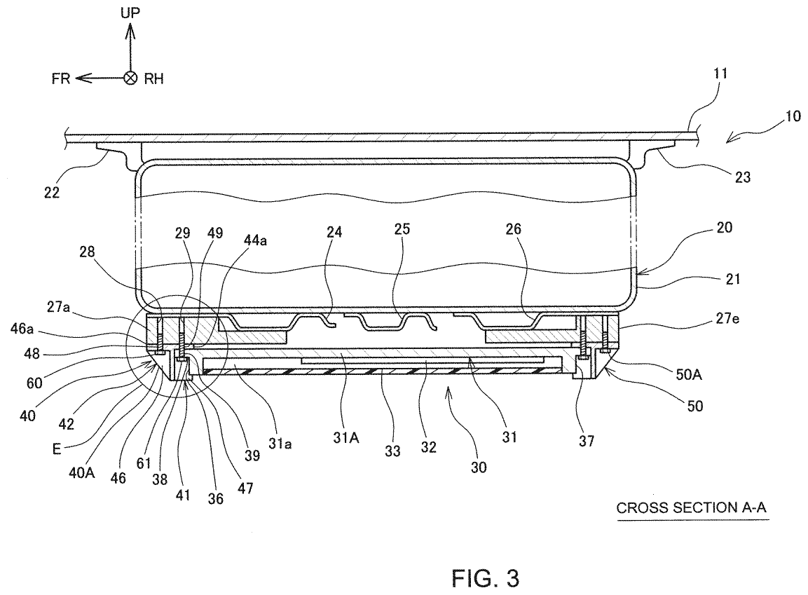

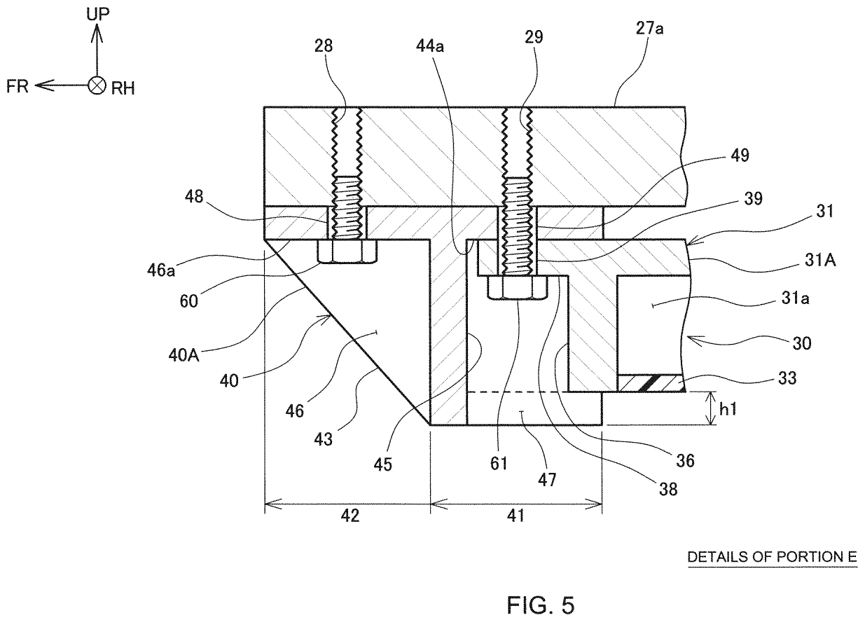

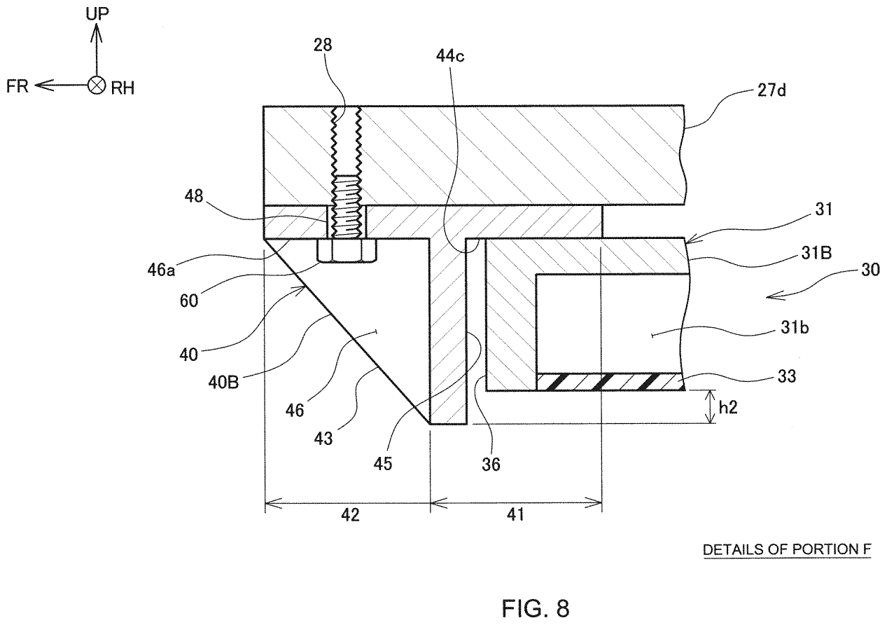

As illustrated in FIG. 2, the battery pack 20 includes a casing 21 that houses therein a battery module (not illustrated). The casing 21 has arms 22 and 23, in the front and rear respectively, that are fixed to the floor panel 11. Reinforcement members 24, 25, and 26 extending in the vehicle width direction are attached to the underside surface of the casing 21. As illustrated in FIG. 3, each of the reinforcement members 24, 25, and 26 is a bent metal plate having one or more grooves. A plurality of metal brackets 27a to 27g are attached to the underside surfaces of the reinforcement members 24 and 26. Each of the brackets 27a to 27g is composed of a thin plate portion and a thick plate portion, the thin plate portion being connected to the underside of a downward projecting portion of the reinforcement member 24 or 26 and the thick plate portion being connected to the underside of an upward projecting portion of the reinforcement member 24 or 26. The undersurfaces of the brackets 27a to 27g are flush with each other. Each of the brackets 27a to 27g has two threaded holes 28 and 29 or one threaded hole 28 (see FIGS. 5 and 8).

As illustrated in FIG. 2, the contactless charging module 30 includes a casing 31, a contactless charger 32, and an auxiliary device 34. The casing 31, which is made of metal, includes a main portion 31A having a main recess 31a that houses therein the contactless charger 32 and a sub-portion 31B having a sub-recess 31b that houses the auxiliary device 34. A resin cover 33 is attached below the main recess 31a, and a metal cover 35 is attached below the sub-recess 31b. The contactless charger 32 contactlessly receives power supply from a power supply module (not illustrated) disposed on the ground through the resin cover 33 and charges a battery module (not illustrated) housed in the battery pack 20 with the supplied power. As illustrated in FIG. 1, the contactless charging module 30 is attached to the battery pack 20 in a manner such that the center of the contactless charger 32 is located in the center of the electrically powered vehicle 10 in the width direction. In FIG. 1, alternate long and short dashed lines 91 extend in the vehicle longitudinal direction through the center in the vehicle width direction. As such, the main portion 31A of the casing 31 is located in the center in the vehicle width direction, and the sub-portion 31B is located in the left side of the vehicle.

The width of the main portion 31A of the casing 31 in the vehicle longitudinal direction is slightly shorter than the width of the sub-portion 31B of the casing 31 in the vehicle longitudinal direction. The casing 31 has a plurality of attaching arms 38 for attaching the contactless charging module 30 to the battery pack 20, the attaching arms 38 protruding in the vehicle longitudinal direction or in the vehicle width direction. Each of the attaching arms 38 has a bolt hole 39 through which a bolt 61, which will be described later, passes.

The front guard member 40 will now be described in detail. The front guard member 40 is a metal longitudinal member that is disposed in front of the contactless charging module 30 and extends in the vehicle width direction. The front guard member 40 includes a center portion 40A that covers the front of the main portion 31A of the casing 31 of the contactless charging module 30 and a side portion 40B that covers the front of the sub-portion 31B of the casing 31 of the contactless charging module 30. Referring first to FIGS. 3 to 5, a structure of the center portion 40A will be described below.

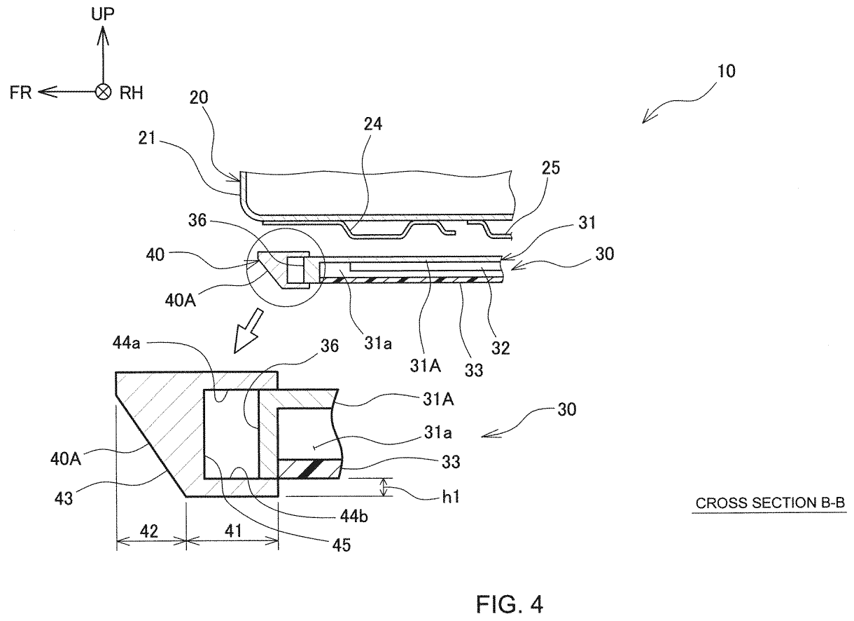

As illustrated in FIG. 4, the center portion 40A includes a base 41 that faces a front surface 36 of the main portion 31A of the casing 31 and a tip 42 that extends from the base 41 toward the front of the vehicle. The base 41 is composed of a substrate 45 and an upper flange 44a and a lower flange 44b, the upper flange 44a and the lower flange 44b extending from the substrate 45 toward the rear of the vehicle. The main portion 31A of the casing 31 is interposed between the upper flange 44a and the lower flange 44b. The lower flange 44b has a lower end surface that protrudes downward by a height hl relative to the undersurface of the resin cover 33 that constitutes a bottom surface of the main portion 31A. The tip 42 is a trapezoidal portion that protrudes from the substrate 45 toward the front and has an undersurface 43 that forms a sloped surface extending from a lower end surface of the substrate 45 toward the front of the vehicle and sloped upward with respect to the vehicle.

As illustrated in FIG. 5, the tip 42 of the center portion 40A has a support 46a for attaching the front guard member 40 to the battery pack 20. The support 46a is a flattened portion that is formed by chipping away a lower side portion of the tip 42 and has, in the center, a bolt hole 48 through which a bolt 60 passes. The lower flange 44b of the base 41 has a cut 47, and the upper flange 44a of the base 41 has a bolt hole 49 through which the bolt 61 passes.

The bolt hole 48 in the support 46a is aligned with a threaded hole 28 in a corresponding one of the brackets 27a to 27c attached below the casing 21 of the battery pack 20, and the support 46a is fixed to the corresponding one of the brackets 27a to 27c via the bolt 60. The bolt hole 49 in the upper flange 44a is aligned with a threaded hole 29 in a corresponding one of the brackets 27a to 27c. An attaching arm 38 of the contactless charging module 30 is then aligned over the upper flange 44a, and the bolt hole 39 in the attaching arm 38 and the bolt hole 49 in the upper flange 44a are aligned with each other. This enables fixing of the upper flange 44a to the corresponding one of the brackets 27a to 27c via the bolt 61 together with the attaching arm 38 of the contactless charging module 30. As such, the center portion 40A of the front guard member 40 is fixed to the brackets 27a to 27c, each via the two bolts 60 and 61.

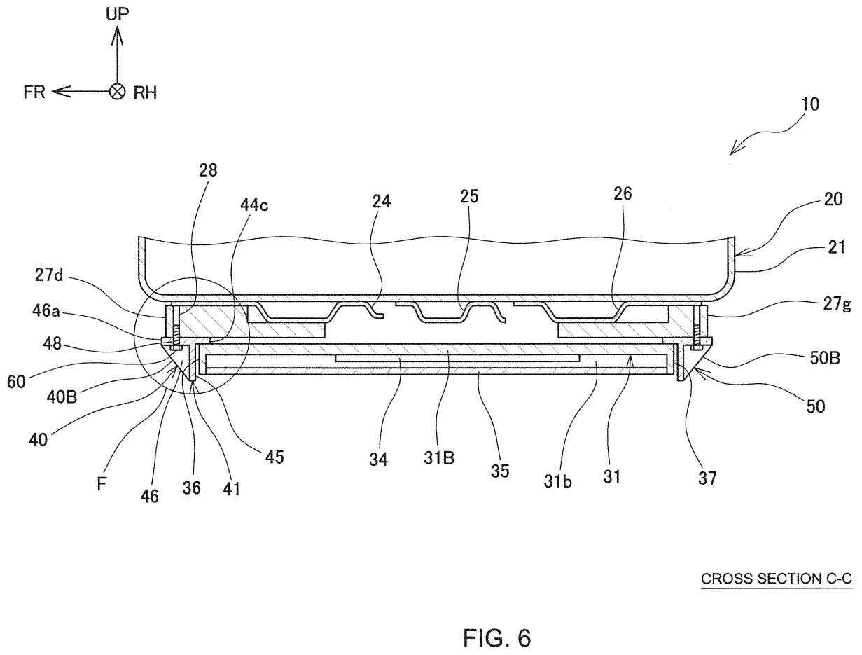

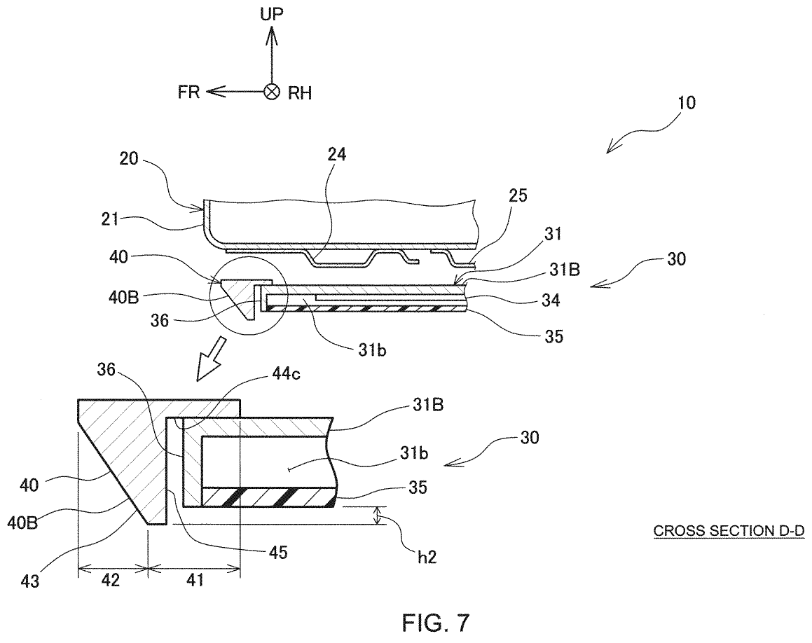

Referring next to FIGS. 6 to 8, a structure of the side portion 40B will be described below. As illustrated in FIGS. 7 and 8, the side portion 40B differs from the center portion 40A in that the sub-portion 31B of the casing 31 of the contactless charging module 30 has a width in the vehicle longitudinal direction that is slightly wider than that of the main portion 31A, and as they have somewhat different shapes, the base 41 does not have the lower flange 44b and an upper flange 44c does not have the bolt hole 49. The remaining portions of the side portion 40B have the same structures as those in the above-described center portion 40A. As in the center portion 40A, the base 41 has a lower end surface that protrudes downward by a height h2 relative to the undersurface of the metal cover 35 that constitutes a bottom surface of the sub-portion 31B. It should be noted that the height h2 may be the same as or may be different from the above-described height h1.

As illustrated in FIG. 8, the support 46a is fixed to the bracket 27d attached to the casing 21 of the battery pack 20 using the bolt 60, but as the sub-portion 31B of the casing 31 does not have the attaching arms 38, the sub-portion 31B is not fixed to the bracket 27d together with the upper flange 44c. It should be noted that, as illustrated in FIG. 2, the left-side end of the sub-portion 31B has a flat portion 38b which is fixed to the casing 21 of the battery pack 20 via a bolt.

As illustrated in FIG. 2, similarly as for the above-described front guard member 40, the rear guard member 50 is composed of a center portion 50A and a side portion 50B. The center portion 50A and the side portion 50B of the rear guard member 50 are symmetric to the center portion 40A and the side portion 40B of the front guard member 40 with respect to a line perpendicular to the vehicle longitudinal direction, covering a rear surface 37 of the casing 31 of the contactless charging module 30; therefore, the rear guard member 50 is not described in further detail.

As the electrically powered vehicle 10 according to the above-described embodiment includes the front guard member 40 and the rear guard member 50 which respectively cover the front surface 36 and the rear surface 37 of the casing 31 of the contactless charging module 30, input of a load from the road surface directly to the contactless charging module 30 while the electrically powered vehicle 10 is traveling toward the front or rear can be suppressed, enabling a reduction in the load from the road surface input to the contactless charging module 30.

Each of the front guard member 40 and the rear guard member 50 includes a base 41 having a lower end surface that protrudes downward with respect to the vehicle by a height h1 or h2 relative to the undersurface of the resin cover 33 or the undersurface of the metal cover 35 that constitutes a bottom surface of the contactless charging module 30, with the undersurface 43 of the tip 42 forming a sloped surface that extends upward with respect to the vehicle. Therefore, in response to input of a load acting in the horizontal direction from the road surface to the front of the front guard member 40 or to the rear of the rear guard member 50, the undersurface 43 of the tip 42, which is sloped, converts some of the load acting in the vehicle longitudinal direction into a load acting in the vehicle vertical direction, reducing shear force applied to the bolt 60 and/or the bolt 61 which fix the front guard member 40 or the rear guard member 50, to thereby suppress damage to the bolts 60 and 61.

This in turn suppresses the possibility of the front guard member 40 or the rear guard member 50 dropping off from the electrically powered vehicle 10, enabling reduction of input of the load from the road surface to the contactless charging module 30.

The undersurface 43, which forms a sloped surface extending upward with respect to the vehicle, rectifies air flowing below the floor panel 11 of the electrically powered vehicle 10, enabling reduction in air resistance, improved electricity consumption, and reduced noise.

The electrically powered vehicle 10 according to an embodiment is configured such that the contactless charging module 30, the front guard member 40, and the rear guard member 50 are attached below the battery pack 20 that is attached below the floor panel 11. The electrically powered vehicle 10 may be a hybrid electric vehicle in which case, as high-temperature components such as an engine exhaust pipe are disposed below the floor panel 11, the temperature of the contactless charging module 30 may exceed its tolerable temperature. However, as the battery pack 20 is not heated to such a high temperature, disposing the contactless charging module 30 below the battery pack 20 can suppress the contactless charging module 30 exceeding its tolerable temperature.

Although the foregoing description indicates that the contactless charging module 30 is disposed below the battery pack 20, the contactless charging module 30 may be attached directly to the floor panel 11 if no high-temperature components are disposed below the floor panel 11, such as when, for example, the electrically powered vehicle 10 is an electric vehicle.

1. An electrically powered vehicle comprising:
a contactless charging module attached below a floor panel, the contactless charging module configured to contactlessly receive power supply from a power supply module disposed on the ground; and
a guard member disposed adjacent to the contactless charging module in a vehicle longitudinal direction below the floor panel,
wherein the guard member is disposed to cover a front surface or a rear surface of the contactless charging module.

2. The electrically powered vehicle according to claim 1,
wherein the guard member includes a base that faces the front surface or the rear surface of the contactless charging module and a tip that extends from the base toward the front or the rear of the vehicle,
wherein the base has a lower end surface that protrudes downward with respect to the vehicle relative to the bottom surface of the contactless charging module, and
wherein the tip has an undersurface that forms a sloped surface extending from the lower end surface of the base upward with respect to the vehicle.

3. The electrically powered vehicle according to claim 2,
wherein the contactless charging module and the guard member are attached below a battery pack that is attached below the floor panel.
